(19) United States
(12) Patent Application Publication
(10) Pub. No.: US 2012/0173236 A1
(43) Pub. Date: Jul. 5, 2012

(54) SPEECH TO TEXT CONVERTING DEVICE AND METHOD

(75) Inventors: YUAN-FU HUANG, Tu-Cheng (TW); TIEN-PING LIU, Tu-Cheng (TW); CHIEN-HUANG CHANG, Tu-Cheng (TW)

(73) Assignee: HON HAI PRECISION INDUSTRY CO., LTD., Tu-Cheng (TW)

(21) Appl. No.: 13/204,958

(22) Filed: Aug. 8, 2011

(30) Foreign Application Priority Data
Dec. 31, 2010 (TW) 99147409

(51) Int. Cl. G10L 15/26

(52) U.S. Cl. 704/235; 704/E15.043

(57) ABSTRACT

A speech to text converting device includes a display, a voice receiving module, and a voice recognition module, an input module, and a control module. The voice receiving module receives a speech within a certain period of time. The voice recognition module converts the speech to voice data. The control module establishes text data corresponding to the voice data and displays the text data, any inputted words, and the relevant time period.

### CROSS-REFERENCE TO RELATED APPLICATIONS

This application is related to co-pending U.S. patent application entitled “SPEECH TO TEXT CONVERTING DEVICE AND METHOD”, Attorney Docket No. US37060, U.S. application Ser. No. ______ filed on ______.

### BACKGROUND

1. Technical Field

The present disclosure relates to speech to text converting devices, and particularly to, a speech to text converting device and a text to speech converting method.

2. Description of Related Art

The human voice needs be recorded in many fields. Whilst there is a device that converts voice to a text, users or speakers may want to input keywords or comments about a certain part of the text in the device while they are speaking, but such keywords or comments are not distinguished from the body of the speech or capable of being independently recorded.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of the speech to text converting device.

FIG. 2 is a flow chart in accordance with an embodiment of a speech to text converting method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

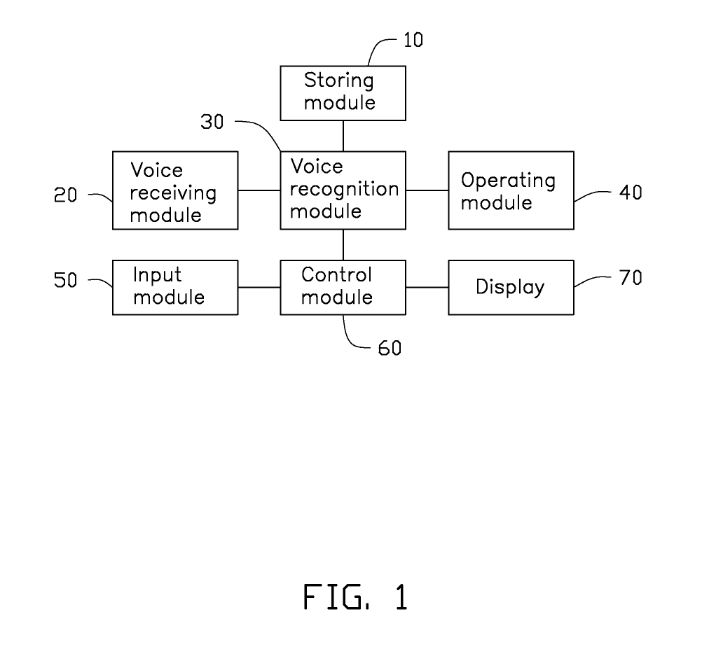

Referring to FIG. 1, a speech to text converting device may be an electronic device and include a storing module 10, a voice receiving module 20, a voice recognition module 30, an operating module 40, an input module 50, a control module 60, and a display 70. In one embodiment, the input module 50 is a touch panel, the operating module 40 is a button, and the voice receiving module 20 is a microphone.

The storing module 10 stores different text data corresponding to different voice data. The voice receiving module 20 receives voice data (speech) from an external source. The voice recognition module 30 converts the speech to the voice data in a time period and sends text data associated with the voice data to the control module 60. The operating module 40 sends a marking or control signal after being pressed. Users can input words to the control module 60 via the input module 50. The control module 60 determines if words have been input via the input module 50. If so, the control module 60 displays the words which have been input and the text data via the display 70. If not, the control module 60 only displays the text data on the display 70. For example, during minute 0-1, the text data is “welcome our manager to give a speech . . . ”. The display 70 displays “00:00:00-00:01:00, welcome our manager to give a speech . . . ”. During minutes 20-21, the text data is “the topic is that . . . ”, and the inputted words are “circuit board trace”. So the display 70 displays “00:20:00-00:21:00, the topic is that . . . , 00:20:00-00:21:00, circuit board trace”. If the user wants to leave for several minutes, he can press the operating module 40. The text data is highlighted on the display during this time of absence.

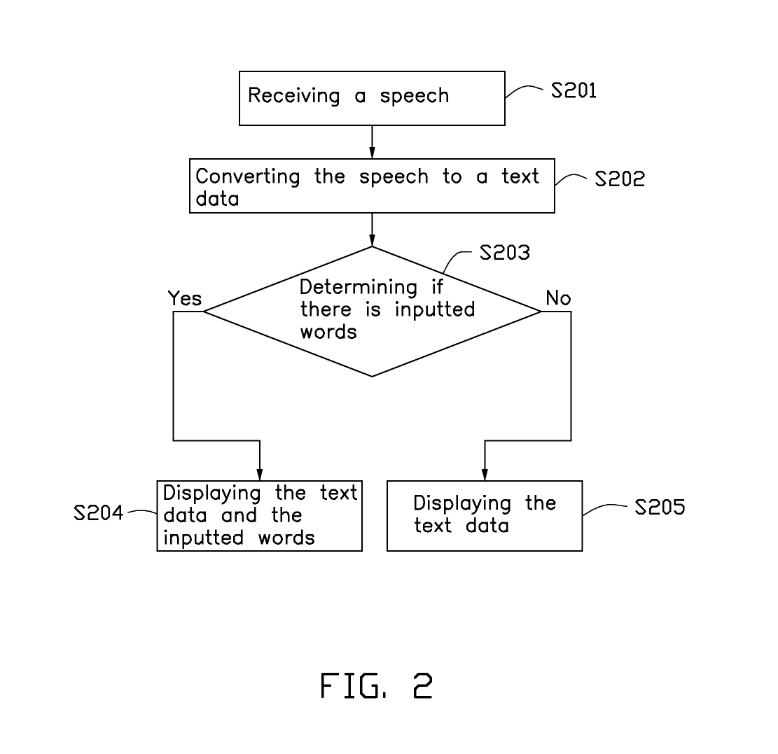

Referring to FIGS. 1 and 2, a speech to text converting method is shown. An embodiment of the method is as follows.

In step S201, the voice receiving module 20 receives a voice signal in a time period and sends it to the voice recognition module 30.

In step S202, the voice recognition module 30 converts the speech to voice data and sends text data associated with the voice data from the storing module 10 to the control module 60.

In step S203, the control module 60 determines if the control module 60 has received words inputted by users via the input module 50. If so, the process continues to step S204. If not, the process continues to step S205.

In step S204, the control module 60 displays the text data and the inputted words on the display 70.

In step S205, the control module 60 displays only the text data on the display 70.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

Depending on the embodiment, certain of the steps of the method described may be removed, others may be added, and the sequence of steps may be altered. It is also to be understood that the description and the claims drawn for a method may include some indication in reference to certain steps. However, the indication used is only to be viewed for identification purposes and not as a suggestion as to an order for the steps.

What is claimed is:

1. A speech to text converting device, comprising:
a display;
a voice receiving module, the voice receiving module adapted to receive a speech and record a time period in which the speech is received;
a voice recognition module, the voice recognition module adapted to convert the speech to a voice data,
an input module, the input module adapted to receive inputted words in the time period; and
a control module, the control module adapted to find a text data associated with the voice data and display the text data, the inputted words, and the time period on the display.

2. The speech to text converting device of claim 1, further comprising an operating module, wherein the operating module is adapted to be pressed to create a control signal to the control module, the control module is adapted to highlight the text data received after the operating module is pressed.

3. The speech to text converting device of claim 2, wherein the control module is adapted to highlight the next text data in a color.

4. The speech to text converting device of claim 1, wherein the input module is a touch panel.

5. A speech to text converting method, applied in a speech to text converting device, the method comprising:
receiving a speech in a time period;
converting the speech to a voice data;
finding a text data associated with the voice data;
accepting words inputted by a user in the time period; and
displaying the text data, the inputted word and the time period.

6. The speech to text converting method of claim 5, further comprising highlighting the text data received after pressing an operating module.

7. The speech to text converting method of claim 5, wherein the speech is received by a microphone.

8. A speech to text converting method comprising:
providing a display, a voice receiving module, a voice recognition module, an input module, and a control module;
receiving a speech in a time period via the voice receiving module;
converting the speech to a voice data via the voice recognition module;
finding a text data associated with the voice data via the control module;
receiving words inputted by a user in the time period via the input module; and
displaying the text data, the inputted word and the time period.
